(19) United States
(12) Patent Application Publication
(10) Pub. No.: US 2025/0117365 A1
(43) Pub. Date: Apr. 10, 2025

(54) METHOD AND SYSTEM FOR EXPEDITIOUSLY DE-ARCHIVING ARCHIVED OBJECTS

(71) Applicant: JPMorgan Chase Bank, N.A., New York, NY (US)

(72) Inventors: Jerome JOSEPH, Lewis Center, OH (US); Kritsakorn CHAUMPANICH, Columbus, OH (US); Shaktikumar HIRASKAR, Monroe Township, NJ (US); Lujain A ALAZAM, Dublin, OH (US)

(73) Assignee: JPMorgan Chase Bank, N.A., New York, NY (US)

(21) Appl. No.: 18/890,518

(22) Filed: Sep. 19, 2024

Related U.S. Application Data
(60) Provisional application No. 63/542,425, filed on Oct. 4, 2023.

(51) Int. Cl. G06F 16/172; G06F 16/11; G06F 16/17

(52) U.S. Cl. CPC G06F 16/172; G06F 16/113; G06F 16/1734

(57) ABSTRACT

A system for expeditiously de-archiving archived objects. The system may include operations that comprise: configuring a first application programing interface (API) gateway between an auxiliary memory system and a repository of archived objects; receiving, via an application, a first user request for a first archived object that is stored within the repository of archived objects; processing the first user request to retrieve the first archived object; pushing, via the first API gateway, the first archived object into the auxiliary memory system that provides high-speed access to objects within the auxiliary memory system; and updating first metadata for the first archived object to store a first log of the retrieving and the pushing.

### CROSS-REFERENCE TO RELATED APPLICATIONS

This application claims priority benefit from U.S. Provisional Application No. 63/542,425, filed Oct. 4, 2023, the contents of which are incorporated herein in their entirety.

### BACKGROUND

### 1. Field

This disclosure generally relates to expediting and retrospectively optimizing a procedure for de-archiving an archived object and, more particularly, to a method, system, and computer-readable storage medium for implementing technology that expeditiously de-archives and retrospectively optimizes the de-archiving of electronically archived data objects.

### 2. Background

Today's organizations process a substantial volume of transactional data daily, which results in massive amounts of data ranging from terabytes to petabytes of data that must be stored data in various archival systems for resiliency and redundancy purposes as well as to meet regulatory and auditing requirements. However, the current approach to retrieving data and file objects from conventional archival system are costly and inefficient, which lead to challenges for both users and the organization processing this transactional data.

For example, the retrieval process of conventional approaches is inefficient because conventional approaches require every requesting application to independently access and retrieve their requested data and, as a result, conventional approaches typically result in redundant efforts, delays and inefficiencies within the operation(s) performed to access the required information. However, such results negatively impact productivity and user experience.

As another example, conventional approaches additionally incur high data transfer and retrieval costs because each application independently retrieves objects from their archive, which results in multiple charges such as a data transfer and data retrieval costs, for example. Therefore, multiple requests can cause costs to accumulate significantly and limit overall budget allocation and cost management efforts over time.

In addition, conventional approaches to the retrieval of archived data also lack centralized control and monitoring system, which hinders an organization's ability to efficiently track and manage retrieval activities and results in potential discrepancies, difficulties in cost attribution, and limits the organization's access to usage patterns.

Another drawback to conventional approaches is that their resource utilization is suboptimal because conventional approaches tend to underutilize one or more resources, which is due to the fact that conventional approaches require that each application independently retrieves the objects that it needs from archive. To be specific, this drawback tends to lead to inefficient resource allocation and higher storage costs by creating redundant copies of the same data and separately storing each copy within a distinct application.

An even further drawback to conventional approaches is that inefficiencies in, and the associated costs of, their retrieval process significantly impact the experience and productivity of the users of such approaches. For example, the required data's accessing delays and potential financial constraints, due to high retrieval costs, tend to prevent users and teams from performing their tasks efficiently, which decreases productivity and can lead to frustration.

Accordingly, in the field of the herein-disclosed invention, there is a need for a technical solution to the foregoing drawbacks to the available archive retrieval techniques existing in today's technology. Therefore, to address these drawbacks, we propose the herein-disclosed centralized and cost-effective archive retrieval solution, which optimizes the archive retrieval process, reduces costs, enables centralized control and monitoring, and enhances user experience and productivity.

### SUMMARY

The present disclosure, through one or more of its various aspects, embodiments, and/or specific features or sub-component, provides, inter alia, various systems, servers, devices, methods, media, programs and platforms for expediting and retrospectively optimizing procedures for de-archiving at least one archived object.

According to an aspect of the present disclosure, a method is provided for a method for expeditiously de-archiving archived objects. The method may comprise: configuring a first application programing interface (API) gateway between an auxiliary memory system and a repository of archived objects; receiving, via an application, a first user request for a first archived object that is stored within the repository of archived objects; processing the first user request to retrieve the first archived object; pushing, via the first API gateway, the first archived object into the auxiliary memory system that provides high-speed access to objects within the auxiliary memory system; and updating first metadata for the first archived object to store a first log of the retrieving and the pushing.

In the method, the processing may further comprise: validating a first set of attributes of the first user request; notifying a user that the first user request has been received and is being processed; retrieving the first archived object from the repository of archived objects; and storing the first set of attributes of the first user request as the first metadata.

In the method, the first user request may comprise a first set of attributes that may include: a first identifier that is assigned to the first archived object, a first user identifier that is assigned to a first requestor of the first user request, a first email address that belongs to the first requestor, a first desired tier of retrieval for retrieving the first archived object from the repository of archived objects, and a first timestamp of the first user request.

In the method, the updating may comprise: determining a first turnaround time of the processing; calculating a first monetary cost of at least one from among the processing and the pushing; and storing, as a first log within the first metadata, the first turnaround time, the first monetary cost and a second timestamp that indicates when the pushing operating has been completed. The first monetary cost may be based on a first size of the first archived object and may also be based on a first desired tier of retrieval for retrieving the first archived object from the repository of archived objects.

In the method, the first desired tier of retrieval may comprise: a desired data rate for at least one from among the retrieving and downloading a retrieved copy of the first archived object from the auxiliary memory system; and a desired turnaround time for the retrieving.

The method may further comprise: configuring a first API between the application and the auxiliary memory system; notifying a user of the first log; receiving, via the application, a first API call to download a retrieved copy of the first archived object from the auxiliary memory system; and downloading, via the first API, the retrieved copy of the first archived object from the auxiliary memory system.

The method may further comprise: performing the receiving, the processing, and the pushing, for each of a plurality of user requests that are each for a respective archived object; respectively performing the updating of respective metadata for the respective archived object to store a respective log of the performing, for each of the plurality of user requests; and respectively storing the respective log within a historical retrieval data repository.

The method may further comprise: evaluating the historical retrieval data repository to identify historical data retrieval trends; and optimizing, based on the historical data retrieval trends, at least one from among the processing and the pushing.

The method may further comprise: generating, based on the historical data retrieval trends, at least one from among at least one graph and at least one report; and displaying, within a graphical user interface (GUI), the at least one from among the at least one graph and the at least one report.

In the method, the optimizing may further comprise at least one from among: performing, based on the historical data retrieval trends, the retrieving and the pushing of the first archived object prior to the receiving, the processing and the updating; and utilizing, based on the historical data retrieval trends, a retrieved copy of the first archived object to fulfill a subsequent user request.

According to another aspect of the present disclosure, a system is provided for expeditiously de-archiving archived objects. The system may comprise: a processor; and memory storing instructions. When executed by the processor, the instructions may cause the processor to perform operations. The operations may comprise: configuring a first application programing interface (API) gateway between an auxiliary memory system and a repository of archived objects; receiving, via an application, a first user request for a first archived object that is stored within the repository of archived objects; processing the first user request to retrieve the first archived object; pushing, via the first API gateway, the first archived object into the auxiliary memory system that provides high-speed access to objects within the auxiliary memory system; and updating first metadata for the first archived object to store a first log of the retrieving and the pushing.

In the system, when the instructions are executed by the processor, the processing may further comprise: validating attributes of the first user request; notifying a user that the first user request has been received and is being processed; retrieving the first archived object from the repository of archived objects; and storing the attributes of the first user request as the first metadata.

In the system, when the instructions are executed by the processor, the first user request may comprise a first set of attributes that may include: a first identifier that is assigned to the first archived object, a first user identifier that is assigned to a first requestor of the first user request, a first email address that belongs to the first requestor, a first desired tier of retrieval for retrieving the first archived object from the repository of archived objects, and a first timestamp of the first user request.

In the system, when the instructions are executed by the processor, the updating may comprise: determining a first turnaround time of the processing; calculating a first monetary cost of at least one from among the processing and the pushing; and storing, as a first log within the first metadata, the first turnaround time, the first monetary cost and a second timestamp that indicates when the pushing operating has been completed. The first monetary cost may be based on a first size of the first archived object and may also be based on a first desired tier of retrieval for retrieving the first archived object from the repository of archived objects.

In the system, when the instructions are executed by the processor, the first desired tier of retrieval may comprise: a desired data rate for at least one from among the retrieving and downloading a retrieved copy of the first archived object from the auxiliary memory system; and a desired turnaround time for the retrieving.

In the system, when executed by the processor, the instructions may cause the processor to perform further operations that comprise: configuring a first API between the application and the auxiliary memory system; notifying a user of the first log; receiving, via the application, a first API call to download a retrieved copy of the first archived object from the auxiliary memory system; and downloading, via the first API, the retrieved copy of the first archived object from the auxiliary memory system.

In the system, when executed by the processor, the instructions may cause the processor to perform further operations that comprise: performing the receiving, the processing, and the pushing, for each of a plurality of user requests that are each for a respective archived object; respectively performing the updating of respective metadata for the respective archived object to store a respective log of the performing, for each of the plurality of user requests; and respectively storing the respective log within a historical retrieval data repository.

In the system, when executed by the processor, the instructions may cause the processor to perform further operations that comprise: evaluating the historical retrieval data repository to identify historical data retrieval trends; and optimizing, based on the historical data retrieval trends, at least one from among the processing and the pushing.

In the system, when executed by the processor, the instructions may cause the processor to perform further operations that comprise: generating, based on the historical data retrieval trends, at least one from among at least one graph and at least one report; and displaying, within a graphical user interface (GUI), the at least one from among the at least one graph and the at least one report.

In the system, when the instructions are executed by the processor, the optimizing may further comprise at least one from among: performing, based on the historical data retrieval trends, the retrieving and the pushing of the first archived object prior to the receiving, the processing and the updating; and utilizing, based on the historical data retrieval trends, a retrieved copy of the first archived object to fulfill a subsequent user request.

According to yet another aspect of the present disclosure, a non-transitory computer-readable medium is provided for expeditiously de-archiving archived objects. The computer-readable medium may store instructions that, when executed by a processor, causes the processor to perform operations. The operations may comprise: configuring a first application programing interface (API) gateway between an auxiliary memory system and a repository of archived objects; receiving, via an application, a first user request for a first archived object that is stored within the repository of archived objects; processing the first user request to retrieve the first archived object; pushing, via the first API gateway, the first archived object into the auxiliary memory system that provides high-speed access to objects within the auxiliary memory system; and updating first metadata for the first archived object to store a first log of the retrieving and the pushing.

In the computer-readable medium, when the instructions are executed by the processor, the processing may further comprise: validating attributes of the first user request; notifying a user that the first user request has been received and is being processed; retrieving the first archived object from the repository of archived objects; and storing the attributes of the first user request as the first metadata.

In the computer-readable medium, when the instructions are executed by the processor, the first user request may comprise a first set of attributes that may include: a first identifier that is assigned to the first archived object, a first user identifier that is assigned to a first requestor of the first user request, a first email address that belongs to the first requestor, a first desired tier of retrieval for retrieving the first archived object from the repository of archived objects, and a first timestamp of the first user request.

In the computer-readable medium, when the instructions are executed by the processor, the updating may comprise: determining a first turnaround time of the processing; calculating a first monetary cost of at least one from among the processing and the pushing; and storing, as a first log within the first metadata, the first turnaround time, the first monetary cost and a second timestamp that indicates when the pushing operating has been completed. The first monetary cost may be based on a first size of the first archived object and may also be based on a first desired tier of retrieval for retrieving the first archived object from the repository of archived objects.

In the computer-readable medium, when the instructions are executed by the processor, the first desired tier of retrieval may comprise: a desired data rate for at least one from among the retrieving and downloading a retrieved copy of the first archived object from the auxiliary memory system; and a desired turnaround time for the retrieving.

In the computer-readable medium, when executed by the processor, the instructions may cause the processor to perform further operations that comprise: configuring a first API between the application and the auxiliary memory system; notifying a user of the first log; receiving, via the application, a first API call to download a retrieved copy of the first archived object from the auxiliary memory system; and downloading, via the first API, the retrieved copy of the first archived object from the auxiliary memory system.

In the computer-readable medium, when executed by the processor, the instructions may cause the processor to perform further operations that comprise: performing the receiving, the processing, and the pushing, for each of a plurality of user requests that are each for a respective archived object; respectively performing the updating of respective metadata for the respective archived object to store a respective log of the performing, for each of the plurality of user requests; and respectively storing the respective log within a historical retrieval data repository.

In the computer-readable medium, when executed by the processor, the instructions may cause the processor to perform further operations that comprise: evaluating the historical retrieval data repository to identify historical data retrieval trends; and optimizing, based on the historical data retrieval trends, at least one from among the processing and the pushing.

In the computer-readable medium, when executed by the processor, the instructions may cause the processor to perform further operations that comprise: generating, based on the historical data retrieval trends, at least one from among at least one graph and at least one report; and displaying, within a graphical user interface (GUI), the at least one from among the at least one graph and the at least one report.

In the computer-readable medium, when the instructions are executed by the processor, the optimizing further may comprise at least one from among: performing, based on the historical data retrieval trends, the retrieving and the pushing of the first archived object prior to the receiving, the processing and the updating; and utilizing, based on the historical data retrieval trends, a retrieved copy of the first archived object to fulfill a subsequent user request.

Thereby, the invention disclosed herein improves existing technology by implementing a system that expedites de-archiving, and retrospectively optimizes the de-archiving, of archived objects.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 is a diagram of a computer system.

FIG. 2 is a diagram of a network environment for implementing an object de-archiving optimization tool that expedites de-archiving, and retrospectively optimizes the de-archiving, of archived objects.

FIG. 3 is a diagram of a network environment that utilizes an object de-archiving optimization tool to expedite de-archiving, and retrospectively optimize the de-archiving, of archived objects.

FIG. 4 is a flowchart of a process for implementing an object de-archiving optimization tool that expedites de-archiving, and retrospectively optimizes the de-archiving, of archived objects.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable storage media having instructions stored thereon for one or more aspects of the present technology as described and illustrated by way of the examples herein. In some examples, the instructions include executable code that, when executed by one or more processors, cause the processors to carry out steps necessary to implement the methods of the examples of this technology that are described and illustrated herein.

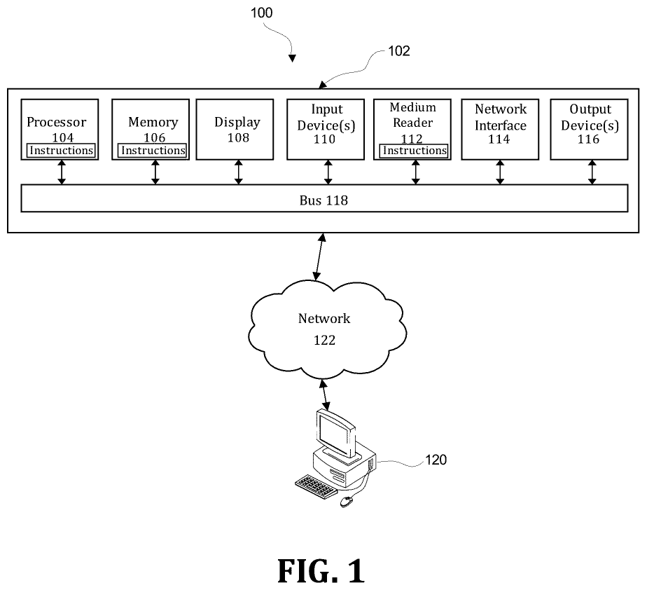

FIG. 1 illustrates a system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data as well as executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g. software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As illustrated in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is illustrated in FIG. 1 as a wireless network, those skilled in the art appreciate that the network 122 may also be a wired network.

The additional computer device 120 is illustrated in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide methods and systems for implementing an object de-archiving optimization tool that expedites de-archiving, and retrospectively optimizes the de-archiving, of archived objects.

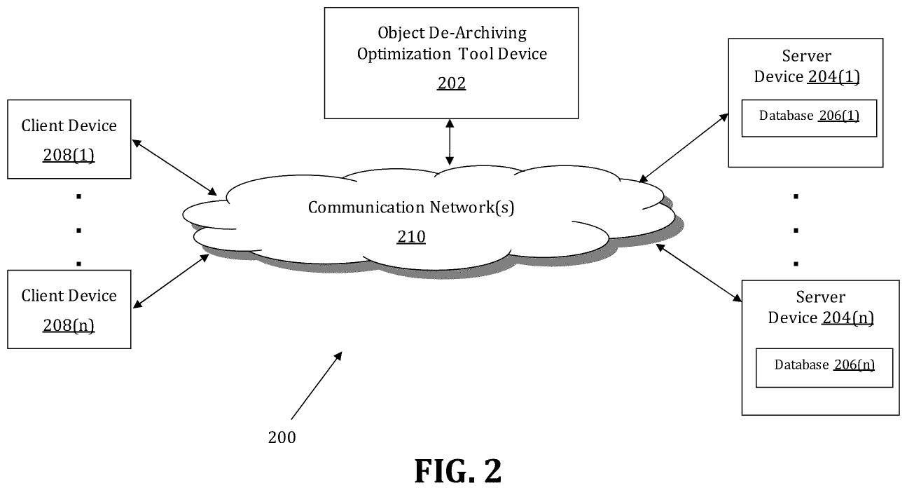

Referring to FIG. 2, a schematic of a network environment 200 is illustrated. The network environment 200 may be configured to implement the object de-archiving optimization tool that expedites de-archiving, and retrospectively optimizes the de-archiving, of archived objects. In an embodiment, the object de-archiving optimization tool may be implemented on any networked computer platform, such as, for example, a personal computer (PC).

A method for expeditiously de-archiving archived objects may be implemented by an Object De-archiving Optimization Tool (ODOT) device 202. The ODOT device 202 may be the same or similar to the computer system 102 as described with respect to FIG. 1. The ODOT device 202 may be a rack-mounted server in a datacenter, an embedded microcontroller (MCU) in an electronic device, or another type of headless system, which is a computer system or device that is configured to operate without a monitor, keyboard and mouse. The ODOT device 202 may store one or more applications that can include executable instructions that, when executed by the ODOT device 202, cause the ODOT device 202 to perform actions, such as to transmit, receive, or otherwise process network communications, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the ODOT device 202 itself, may be located in virtual server(s) running in a cloud-based computing environment rather than being tied to one or more specific physical network computing devices. Also, the application(s) may be running in one or more virtual machines (VMs) executing on the ODOT device 202. Additionally, in one or more embodiments of this technology, virtual machine(s) running on the ODOT device 202 may be managed or supervised by a hypervisor.

In the network environment 200 of FIG. 2, the ODOT device 202 is coupled to a plurality of server devices 204(1)-204(n) that hosts a plurality of databases 206(1)-206(n), and also to a plurality of client devices 208(1)-208(n) via communication network(s) 210. A communication interface of the ODOT device 202, such as the network interface 114 of the computer system 102 of FIG. 1, operatively couples and communicates between the ODOT device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the ODOT device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, computer readable media, and ODOT devices that efficiently implement a method for an object de-archiving optimization tool that expedites and retrospectively optimizes procedures for de-archiving at least one archived object.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The ODOT device 202 may be a standalone device or integrated with one or more other devices or apparatuses, such as one or more of the server devices 204(1)-204(n), for example. In one particular example, the ODOT device 202 may include or be hosted by one of the server devices 204(1)-204(n), and other arrangements are also possible. As another example, the ODOT device 202 may be integrated with one or more other devices or apparatuses, such as one or more of the client devices 208(1)-208(n). Moreover, one or more of the devices of the ODOT device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the ODOT device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store data that relates to a variety of databases.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the ODOT device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an embodiment, at least one client device 208 is a wireless mobile communication device, i.e., a smart phone.

The client devices 208(1)-208(n) may run interface applications, such as standard web browsers or standalone client applications, which may provide an interface to communicate with the ODOT device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the ODOT device 202, the server devices 204(1)-204(n), the databases 206(1)-206(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the ODOT device 202, the server devices 204(1)-204(n), the databases 206(1)-206(n), or the client devices 208(1)-208(n), for example, may be configured to operate as virtual instances on the same physical machine. In other words, one or more of the ODOT device 202, the server devices 204(1)-204(n), the databases 206(1)-206(n), or the client devices 208(1)-208(n) may operate on the same physical device rather than as separate devices communicating through communication network(s) 210. Additionally, there may be more or fewer ODOT devices 202, server devices 204(1)-204(n), databases 206(1)-206(n), or client devices 208(1)-208(n) than illustrated in FIG. 2.

In addition, two or more computing systems, databases or devices may be substituted for any one of the systems, databases or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

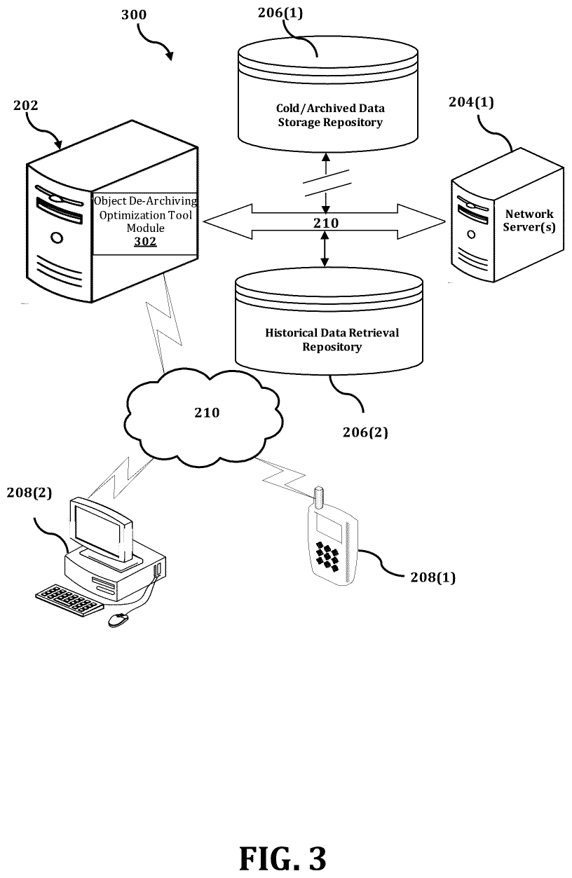

Referring to FIG. 3, the ODOT device 202 is described and illustrated in FIG. 3 as including object de-archiving optimization tool module 302, although it may include other rules, policies, modules, databases, or applications, for example. As will be described below, object de-archiving optimization tool module 302 is configured to expedite de-archiving, and retrospectively optimize the de-archiving, of archived objects. In an embodiment, object de-archiving optimization tool module 302 may include software that is based on a microservices architecture.

Object de-archiving optimization tool module 302 may be integrated with one or more devices or apparatuses, such as client devices 208(1)-208(n), where object de-archiving optimization tool module 302 may be implemented as an application or as an addon or plugin to another application of the one or more devices or apparatuses, and where object de-archiving optimization tool module 302 may execute in the background.

An exemplary process 300 for application of an object de-archiving optimization tool to an aspect of the network environment of FIG. 2 is illustrated as being executed in FIG. 3. Specifically, a first client device 208(1) and a second client device 208(2) are illustrated as being in communication with ODOT device 202. In this regard, the first client device 208(1) and the second client device 208(2) may be “clients” of the ODOT device 202 and are described herein as such. Nevertheless, it is to be known and understood that the first client device 208(1) and/or the second client device 208(2) need not necessarily be “clients” of the ODOT device 202, or any entity described in association therewith herein. Any additional or alternative relationship may exist between either or both of first client device 208(1), second client device 208(2) and ODOT device 202, or no relationship may exist.

Further, ODOT device 202 is illustrated as being able to access cold/archived data storage repository 206(1) and historical data retrieval repository 206(2). ODOT device 202 may comprise an object de-archiving optimization tool that communicates with cold/archived data storage repository 206(1). In addition, the object de-archiving optimization tool of ODOT device 202 may also communicate with historical data retrieval repository 206(2). Object de-archiving optimization tool module 302 may be configured to access these databases in order to incorporate expedite de-archiving, and retrospectively optimize the de-archiving, of archived objects.

Moreover, ODOT device 202 may receive and transmit data via communication network(s) 210. ODOT device 202 may receive and transmit data such as code that is written in one or more of the following dialects: transaction control language (TCL), data manipulation language (DML), data control language (DCL) and data definition language (DFL). Additionally, via communication network(s) 210, ODOT device 202 may respectively receive and transmit data from and to one or more from among the following devices: server device 204, cold/archived data storage repository 206(1), historical data retrieval repository 206(2) (or another database 206), first client device 208(1), the second client device 208(2), and communication network(s) 210, for example.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The client devices 208(1)-208(n) may represent, for example, computer systems of an organization or database network. The first client device 208(1) represent, for example, one or more computer systems of a department or cluster within the organization or database network. Of course, the first client device 208(1) may include one or more of any of the devices described herein. The second client device 208(2) may be, for example, one or more computer systems of another department or cluster within the organization or database network. Of course, the second client device 208(2) may include one or more of any of the devices described herein.

The process may be executed via the communication network(s) 210, which may comprise plural networks as described above. For example, in an embodiment, either or both of the first client device 208(1) and the second client device 208(2) may communicate with the ODOT device 202 via broadband or cellular communication. Of course, these embodiments are merely exemplary and are not limiting or exhaustive.

Object de-archiving optimization tool module 302 may execute a process for implementing an object de-archiving optimization tool that expedites de-archiving, and retrospectively optimizes the de-archiving, of archived objects.

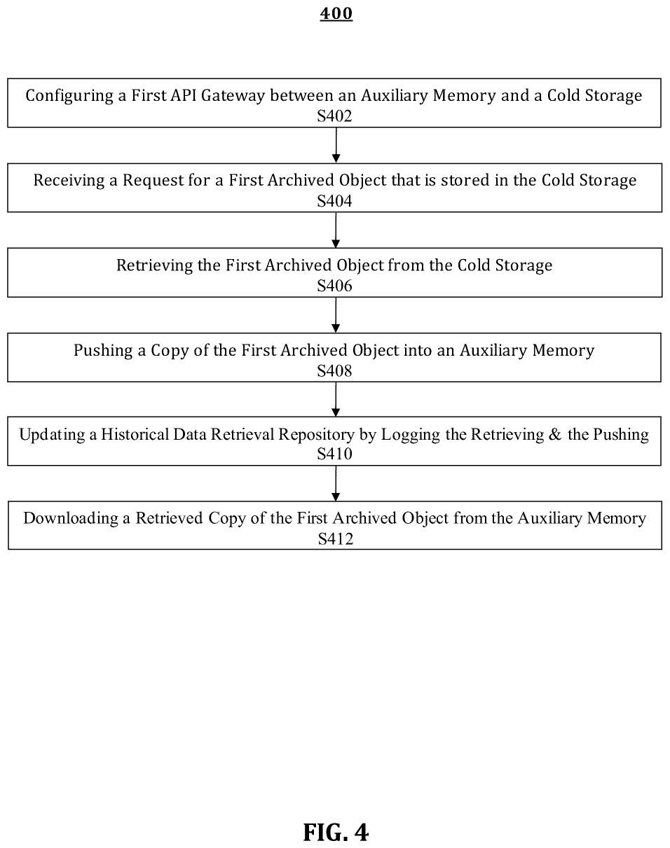

Referring to FIG. 4,a process 400 for implementing an object de-archiving optimization tool is illustrated as a flowchart. At step S402, object de-archiving optimization tool module 302 may configure a first application programming interface (API) gateway between an auxiliary memory and a first cold storage system. The first cold storage system may comprise one or more databases such as cold/archived data storage repository 206(1), which may refer to a memory or database system that is designed to retain inactive data.

For security purposes, the first cold storage system may also comprise one or more features from among a group of features comprising: publicly inaccessible, inaccessible via cross domain access, auto-versioning and/or auto-purging enabled (for stored files or objects), and encrypted. For security purposes, the first cold storage may also enable API key and/or OAuth2.0 authentication, for example, to provide secure access to one or more of its API endpoints. In an embodiment, to configure the first API gateway, object de-archiving optimization tool module 302 may expose a first set of API endpoints of the first cold storage system, and the first API gateway may interface with the first cold storage system via the first set of API endpoints.

To provide access to the first cold storage, object de-archiving optimization tool module 302 may create an identity and access management (IAM) role that includes any first cold storage access permissions that are necessary for that role. In an embodiment, object de-archiving optimization tool module 302 may attach the IAM role to a front-end of the object de-archiving optimization tool module 302.

Accordingly, in an embodiment, at least one user and/or administrator may utilize object de-archiving optimization tool module 302 (or another such front-end application) to request data from the first cold storage system, while engineering teams can programmatically integrate with the first API gateway for such requests. In a further embodiment, requested data may be retrieved from the first cold storage system by calling the first set of API endpoints that correspond to one or more locations of requested data.

In yet an even further embodiment, object de-archiving optimization tool module 302 may transmit one or more API calls for requested data along with the mode of archival/de-archiving. Additionally, or alternatively, for added security, object de-archiving optimization tool module 302 may append an authentication token to such API calls, or two-step verification may be performed by also having the requestor enter login (or biometric) credentials or by also emailing an authentication code to a requestor and then confirming that authentication code with the requestor.

At step S404, object de-archiving optimization tool module 302 may receive a first user request for a first archived object that is stored within the first cold storage system. More particularly, at step S404, object de-archiving optimization tool module 302 receives the first user request from a first user device such as a first client device 208. In an embodiment, the first user request that is received at step S404 may comprise one or more features of the API calls mentioned above. In an additional or alternative embodiment, a data retrieval request, such as the first user request of step S404, may comprise one or more from among file key information, a requested tier of retrieval, a requestor identifier, and a requestor email address.

At step S406, object de-archiving optimization tool module 302 may retrieve the first archived object from the first cold storage system. In an embodiment, object de-archiving optimization tool module 302 may retrieve the first archived object from the first cold storage system by invoking a first set of step functions of a visual workflow service. In the embodiment, the first set of step functions may be part of a first workflow that comprises a series of data retrieval operations. In the embodiment, error handling states may be added to the first set of step functions to handle any failures or exceptions that may arise during the first workflow (error handling states may actually be added to any workflow's respective set of step functions).

In an embodiment, the first set of step functions may retrieve the first archived object from the first cold storage system by performing one or more operations from among a group of operations that comprise: validating a first set of attributes of the first user request; notifying a user (via email or a GUI of module 302) that the first user request has been received and is being processed; retrieving the first archived object from the repository of archived objects; and storing the first set of attributes of the first user request as first metadata that is associated with the first archived object.

In an embodiment, the first metadata may be stored within a historical data retrieval repository, such as historical data retrieval repository 206(2), for example. In an embodiment, the first metadata may be stored within a first table of the historical data retrieval repository, and the first table may comprise a structured query language (SQL) and/or a non-SQL (or NoSQL) database table. In the embodiment, the storing may comprise saving relevant information (e.g., an object ID such as a filekey, retrieval status, timestamp, submitted date, requestor, days for request, object retrieval tier, content length, content type, storage class, execution name, etc.) within the historical data retrieval repository. In yet an even further embodiment, prior to the retrieving, the validating may comprise validating one or more from among: a first identifier (such as an object ID or filekey) of the first archived object, a requested tier of retrieval (e.g., the object retrieval tier) for that first archived object, and one or more other attributes (e.g., action, bucket info, IAM role, etc.).

In an embodiment, the first user request may comprise the first set of attributes, which may include one or more from among: the first identifier that is assigned to the first archived object, a first user identifier that is assigned to a first requestor that triggered the first user request, a first email address that belongs to the first requestor, a first desired tier of retrieval for retrieving the first archived object from a repository of archived objects (e.g., cold/archived data storage repository 206(1)), and a first timestamp of the first user request.

At step S408, object de-archiving optimization tool module 302 may push a copy of the first archived object into an auxiliary memory system. In an embodiment, the first archived object may be pushed into the auxiliary memory system by; creating an eventbridge rule that captures a restore complete event that is transmitted from the first cold storage system once the first archived object has been retrieved; and having the evenbridge the rule trigger a second workflow comprising a second set of step functions that perform post-processing functions on the first user request when the restore complete event is captured.

At step S410, object de-archiving optimization tool module 302 may update the historical data retrieval repository with a first log of the retrieving and the pushing. In an embodiment, the historical data retrieval repository may be updated by a post-processing function from among the second set of step functions that make up the second workflow.

Additionally, in an embodiment, the post-processing function may comprise, for example, a lambda function state (or another function) that calculates at least one from among a first estimated cost of the retrieving of step S406 and a second estimated cost of the pushing of step S408 and then stores lambda function state's calculation(s) within the historical data retrieval repository.

In the embodiment, the post-processing function may update the historical data retrieval repository by storing, within the first table, the first estimated cost and/or the second estimated cost. Also, in the embodiment, the first estimated cost and the second estimated cost may be based on one or more of the first archived object's size, a duration of the retrieving, tier of retrieval, and a data transfer rate of one or more from among the retrieving, the pushing, and downloading a retrieved copy of the first archived object from the auxiliary memory. Moreover, in the embodiment, the second workflow may comprise a function that notifies the requestor (via email and/or a GUI of module 302) of the first estimated cost and/or the second estimated cost.

In a further embodiment, the post-processing function (e.g., the lambda step function) may update the historical data retrieval repository by having it (e.g., the first table) store (against the first archived object's key information, e.g., a first filekey) one or more from among a first timestamp of the first user request, a first turnaround time of the retrieving and/or the pushing, and a status of the first archived object. Then, in yet an even further embodiment, one or more federated queries may be utilized to synchronize the first table with an interactive query service that analyzes data directly using standard SQL.

In an embodiment, a tier of retrieval such as the first desired tier of retrieval may comprise: a desired data rate for at least one from among the retrieving and downloading a retrieved copy of the first archived object from the auxiliary memory system; and a desired turnaround time for the retrieving.

At step S412, object de-archiving optimization tool module 302 may download a retrieved copy of the first archived object from the auxiliary memory. In an embodiment, the retrieved copy of the first archived object may be downloaded from the auxiliary memory via a first API that has been configured between object de-archiving optimization tool module 302 and the auxiliary memory system.

Accordingly, in an embodiment, prior to the downloading of step S412, object de-archiving optimization tool module 302 may configure a second API gateway between itself (i.e., module 302) and the auxiliary memory system. In a further embodiment, a notification about the first log may be sent (via email or a GUI of module 302) to a user (e.g., the “requestor”) by object de-archiving optimization tool module 302. In yet an even further embodiment, object de-archiving optimization tool module 302 transmit an API call to download the retrieved copy of the first archived object from the auxiliary memory.

In an embodiment, the downloading of step S412 may also comprise creating a third step function (e.g., a lambda function) that generates a pre-signed (i.e., utilizing a public key encryption digital signature) universal resource locator (URL) from which the retrieved copy of the first (or a subsequent) archived object may be retrieved. In a further embodiment, a user (e.g., the requestor) may retrieve the retrieved copy of the first (or a subsequent) archived object by utilizing an object ID that has been received as a parameter in a API gateway request (e.g., a second API gateway call) to download such object.

After step S412, process 400 may end or be repeated any number of times. In an embodiment, process 400 may be repeated by: first performing, for each subsequent user request for a desired archived object, the receiving of step S404, the retrieving of step S406 and the pushing of step S408; and then by storing a subsequent log of the receiving of step S404, the retrieving of step S406 and the pushing of step S408. In a further embodiment, subsequent log within the historical data retrieval repository as subsequent metadata that is associated with the desired archived object.

In an embodiment, process 400 may be utilized for test and deployment purposes to ensure that all components of the system for are functioning correctly. More particularly, to ensure that all components of the system for are functioning correctly, object de-archiving optimization tool module 302 may: utilize sample data to test each step of a workflow; deploy the first API gateway, the second API gateway, the lambda step function, the lambda function, the first workflow, the second workflow, and any other necessary resources.

In an embodiment, the historical data retrieval repository may be analyzed to identify trends in the historical data retrieval repository. In the embodiment, the identification of trends in the historical data retrieval repository may comprise: generating, based on contents of the historical data retrieval repository, at least one from among at least one graph and at least one report; and displaying, within a graphical user interface (GUI) of object de-archiving optimization tool module 302, the at least one from among the at least one graph and the at least one report.

In an embodiment, the historical data retrieval repository may also optimize one or more from among the retrieving of step S406, the pushing of step S408 and the downloading of step S412. In a further embodiment, object de-archiving optimization tool module 302 may perform an optimization by performing at least one operations from among a group of operations that comprise: performing, based on historical data retrieval trends, the retrieving of step S406 and the pushing of step S408 prior to the receiving of step S402; and utilizing, based on the historical data retrieval trends, the retrieved copy of the first archived object to fulfill a subsequent request.

Accordingly, with this technology, a process for expediting a de-archiving of one or more archived objects, is provided by process 400.

Although the invention has been described with reference to several embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

What is claimed is:

1. A method for expeditiously de-archiving archived objects, the method comprising:
configuring a first application programing interface (API) gateway between an auxiliary memory system and a repository of archived objects;
receiving, via an application, a first user request for a first archived object that is stored within the repository of archived objects;
processing the first user request to retrieve the first archived object;
pushing, via the first API gateway, the first archived object into the auxiliary memory system that provides high-speed access to objects within the auxiliary memory system; and
updating first metadata for the first archived object to store a first log of the retrieving and the pushing.

2. The method of claim 1, wherein the processing further comprises:
validating a first set of attributes of the first user request;
notifying a user that the first user request has been received and is being processed;
retrieving the first archived object from the repository of archived objects; and
storing the first set of attributes of the first user request as the first metadata.

3. The method of claim 1, wherein the first user request comprises a first set of attributes that includes: a first identifier that is assigned to the first archived object, a first user identifier that is assigned to a first requestor of the first user request, a first email address that belongs to the first requestor, a first desired tier of retrieval for retrieving the first archived object from the repository of archived objects, and a first timestamp of the first user request.

4. The method of claim 1, wherein the updating comprises:
determining a first turnaround time of the processing;
calculating a first monetary cost of at least one from among the processing and the pushing, wherein the first monetary cost is based on a first size of the first archived object and is also based on a first desired tier of retrieval for retrieving the first archived object from the repository of archived objects; and
storing, as a first log within the first metadata, the first turnaround time, the first monetary cost and a second timestamp that indicates when the pushing operating has been completed.

5. The method of claim 4, wherein the first desired tier of retrieval comprises: a desired data rate for at least one from among the retrieving and downloading a retrieved copy of the first archived object from the auxiliary memory system; and a desired turnaround time for the retrieving.

6. The method of claim 1, further comprising:
configuring a first API between the application and the auxiliary memory system;
notifying a user of the first log;
receiving, via the application, a first API call to download a retrieved copy of the first archived object from the auxiliary memory system; and
downloading, via the first API, the retrieved copy of the first archived object from the auxiliary memory system.

7. The method of claim 1, further comprising:
performing the receiving, the processing, and the pushing, for each of a plurality of user requests that are each for a respective archived object;
respectively performing the updating of respective metadata for the respective archived object to store a respective log of the performing, for each of the plurality of user requests; and
respectively storing the respective log within a historical retrieval data repository.

8. The method of claim 7, further comprising:
evaluating the historical retrieval data repository to identify historical data retrieval trends; and
optimizing, based on the historical data retrieval trends, at least one from among the processing and the pushing.

9. The method of claim 8, further comprising:
generating, based on the historical data retrieval trends, at least one from among at least one graph and at least one report; and
displaying, within a graphical user interface (GUI), the at least one from among the at least one graph and the at least one report.

10. The method of claim 8, wherein the optimizing further comprises at least one from among:
performing, based on the historical data retrieval trends, the retrieving and the pushing of the first archived object prior to the receiving, the processing and the updating; and
utilizing, based on the historical data retrieval trends, a retrieved copy of the first archived object to fulfill a subsequent user request.

11. A system for expeditiously de-archiving archived objects, the system comprising:
a processor; and
memory storing instructions that, when executed by the processor, cause the processor to perform operations that comprise:
configuring a first application programing interface (API) gateway between an auxiliary memory system and a repository of archived objects;
receiving, via an application, a first user request for a first archived object that is stored within the repository of archived objects;
processing the first user request to retrieve the first archived object;
pushing, via the first API gateway, the first archived object into the auxiliary memory system that provides high-speed access to objects within the auxiliary memory system; and
updating first metadata for the first archived object to store a first log of the retrieving and the pushing.

12. The system of claim 11, wherein when the instructions are executed by the processor, the processing further comprises:
validating attributes of the first user request;
notifying a user that the first user request has been received and is being processed;
retrieving the first archived object from the repository of archived objects; and
storing the attributes of the first user request as the first metadata.

13. The system of claim 11, wherein when the instructions are executed by the processor, the updating comprises:
determining a first turnaround time of the processing;
calculating a first monetary cost of at least one from among the processing and the pushing, wherein the first monetary cost is based on a first size of the first archived object and is also based on a first desired tier of retrieval for retrieving the first archived object from the repository of archived objects; and
storing, as a first log within the first metadata, the first turnaround time, the first monetary cost and a second timestamp that indicates when the pushing operating has been completed.

14. The system of claim 11, wherein when executed, the instructions cause the processor to perform further operations that comprise:
configuring a first API between the application and the auxiliary memory system;
notifying a user of the first log;
receiving, via the application, a first API call to download a retrieved copy of the first archived object from the auxiliary memory system; and
downloading, via the first API, the retrieved copy of the first archived object from the auxiliary memory system.

15. The system of claim 11, wherein when executed, the instructions cause the processor to perform further operations that comprise:
performing the receiving, the processing, and the pushing, for each of a plurality of user requests that are each for a respective archived object;
respectively performing the updating of respective metadata for the respective archived object to store a respective log of the performing, for each of the plurality of user requests; and
respectively storing the respective log within a historical retrieval data repository.

16. A non-transitory computer-readable medium for expeditiously de-archiving archived objects, wherein the computer-readable medium stores instructions that, when executed by a processor, causes the processor to perform operations that comprise:
configuring a first application programing interface (API) gateway between an auxiliary memory system and a repository of archived objects;
receiving, via an application, a first user request for a first archived object that is stored within the repository of archived objects;
processing the first user request to retrieve the first archived object;
pushing, via the first API gateway, the first archived object into the auxiliary memory system that provides high-speed access to objects within the auxiliary memory system; and
updating first metadata for the first archived object to store a first log of the retrieving and the pushing.

17. The computer-readable medium of claim 16, wherein when executed, the instructions cause the processor to perform further operations that comprise:
performing the receiving, the processing, and the pushing, for each of a plurality of user requests that are each for a respective archived object;
respectively performing the updating of respective metadata for the respective archived object to store a respective log of the performing, for each of the plurality of user requests; and
respectively storing the respective log within a historical retrieval data repository.

18. The computer-readable medium of claim 17, wherein when executed, the instructions cause the processor to perform further operations that comprise:
evaluating the historical retrieval data repository to identify historical data retrieval trends; and
optimizing, based on the historical data retrieval trends, at least one from among the processing and the pushing.

19. The computer-readable medium of claim 18, wherein when executed, the instructions cause the processor to perform further operations that comprise:
generating, based on the historical data retrieval trends, at least one from among at least one graph and at least one report; and
displaying, within a graphical user interface (GUI), the at least one from among the at least one graph and the at least one report.

20. The computer-readable medium of claim 18, wherein the optimizing further comprises at least one from among:
performing, based on the historical data retrieval trends, the retrieving and the pushing of the first archived object prior to the receiving, the processing and the updating; and
utilizing, based on the historical data retrieval trends, a retrieved copy of the first archived object to fulfill a subsequent user request.
